(19) United States
(12) Patent Application Publication
(10) Pub. No.: US 2022/0126868 A1
(43) Pub. Date: Apr. 28, 2022

(54) METHOD AND APPARATUS FOR CONTROLLING AUTONOMOUS DRIVING OF VEHICLE

(71) Applicant: Sungbin Yim, Seongnam-si (KR)

(72) Inventor: Sungbin Yim, Seongnam-si (KR)

(21) Appl. No.: 17/509,287

(22) Filed: Oct. 25, 2021

(30) Foreign Application Priority Data
Oct. 26, 2020 (KR) 10-2020-0139004

(51) Int. Cl. B60W 60/00; B60W 50/00

(52) U.S. Cl. CPC B60W 60/0015; B60W 50/00; B60W 2050/0026; B60W 2720/10; B60W 2720/12; B60W 2556/45; B60W 2554/802; B60W 2530/10; B60W 2552/15; B60W 2552/40; B60W 2555/20; B60W 2754/30

(57) ABSTRACT

A method for controlling autonomous driving of a vehicle according to the present invention comprises the steps of: constructing a safe stopping distance table including multiple preset stopping levels corresponding to multiple stopping distances determined based on multiple stopping variables required for calculating a safe stopping distance; acquiring current stopping variables required for calculating the safe stopping distance during autonomous driving; determining any one of the preset stopping levels as a current stopping level based on the acquired current stopping variables; selecting a certain stopping distance corresponding to the determined current stopping level as a current stopping distance, using the safe stopping distance table, and controlling a driving speed of the vehicle so that a distance between the vehicle and a preceding vehicle is maintained as the selected current stopping distance.

### FIELD OF THE INVENTION

The present invention relates to a method and an apparatus for controlling driving speed of an autonomous driving vehicle, more particularly to a method and an apparatus for controlling autonomous driving of a vehicle that can calculates stopping distance based on stopping variables of the vehicle during autonomous driving and controlling the driving speed of the autonomous driving vehicle based on the calculated stopping distance.

### BACKGROUND OF THE INVENTION

As is known, with the development of technologies such as sensor technology and radar technology for detecting driving situation and environment around roads, technologies related to autonomous driving vehicle are developing all over the world.

Recently, vehicles with low or medium level of autonomous driving technology have been developed, and driving tests of these vehicles are being conducted on the actual roads. Particularly, the driving tests are being performed in certain areas which allow limited driving, such as university campuses or amusement parks.

The autonomous driving vehicle maintains distance from a preceding vehicle driving ahead within a certain preset distance range using a sensor or radar mounted on a certain position of the vehicle. In this instance, the preset distance range may mean stopping distance at which the following autonomous driving vehicle can stop without colliding with the preceding vehicle when the preceding vehicle stops or even makes a sudden stop.

However, it is known that the stopping distance of a vehicle show big differences depending on various stopping variables including driving speed, vehicle weight, road inclination, road friction coefficient, and weather conditions such as rainwater, snow, etc.

Since the conventional autonomous driving methods do not consider various stopping variables, the actual stopping distance of the vehicle becomes relatively longer than the expected stopping distance due to sudden changes of stopping variables. This may lead to vehicle accidents in which the following vehicle collides with the preceding vehicle when the preceding vehicle comes to a sudden stop.

### PRIOR ARTS

### Patent Document

(Patent Document 0001) Korean Patent Application Publication No. 10-2017-0118490, published on Oct. 25, 2017.

### TECHNICAL PROBLEM

The present invention provides a method and an apparatus for controlling autonomous driving of a vehicle that can calculate a safe stopping distance based on stopping variables of the vehicle during autonomous driving and adaptively control a driving speed of the autonomous driving vehicle based on the calculated stopping distance.

The problem to be solved by the present invention is not limited to the mentioned above, and another problem to be solved that is not mentioned can be clearly understood from the description below by those of ordinary skill in the art of the present invention.

### SUMMARY OF THE INVENTION

According to one perspective, the present invention may provide a method for controlling autonomous driving of a vehicle, the method comprising the steps of: constructing a safe stopping distance table including a plurality of preset stopping levels corresponding to a plurality of stopping distances determined based on a plurality of stopping variables required for calculating a safe stopping distance of the vehicle; acquiring current stopping variables required for calculating the safe stopping distance during autonomous driving of the vehicle; determining any one of the preset stopping levels as a current stopping level based on the acquired current stopping variables; selecting a certain stopping distance corresponding to the determined current stopping level as a current stopping distance, by searching the safe stopping distance table, and controlling a driving speed of the vehicle so that a distance between the vehicle and a preceding vehicle is maintained as the selected current stopping distance.

Constructing the safe stopping distance table may be performed through learning using an artificial intelligence (AI) algorithm.

The stopping variables may include at least two of driving speed of the vehicle, weight of the vehicle, road inclination, road friction coefficient, and weather information.

The weather information may be received from a remote weather server through a weather information system mounted on the vehicle.

The weather information may include more than one of rain, heavy rain, snow, heavy snow, fog, fog formed in a forward view of the vehicle.

According to another perspective, the present invention may provide an apparatus for controlling autonomous driving of a vehicle, the apparatus comprising: a data storage part storing a safe stopping distance table including a plurality of preset stopping levels respectively corresponding to a plurality of stopping distances determined based on a plurality of stopping variables required for calculating a safe stopping distance of the vehicle; a stopping variable collection unit acquiring current stopping variables required for calculating the safe stopping distance during autonomous driving of the vehicle; a stopping level determination unit determining any one of the preset stopping levels as a current stopping level based on the current stopping variables of the vehicle; a stopping distance selection unit selecting a certain stopping distance corresponding to the current stopping level determined by searching the safe stopping distance table, as a current stopping distance; and an autonomous driving control unit controlling a driving speed of the vehicle so that a distance between the present vehicle and the preceding vehicle of the present vehicle is maintained as the selected current stopping distance.

The safe stopping distance table may be performed through learning using an artificial intelligence (AI) algorithm.

The stopping variable collection unit may acquire at least two of driving speed of the vehicle, weight of the vehicle, road inclination, road friction coefficient, and weather information, as the current stopping variables.

The stopping variable collection unit may acquire the weather information related to a current location of the vehicle from a remote weather server through a weather information system mounted on the vehicle.

The stopping variable collection unit may acquire weather condition including more than one of rain, heavy rain, snow, heavy snow, fog, fog formed in a forward view of the vehicle as the weather information through a sensor mounted on a certain position of the vehicle.

The stopping variable collection unit may include a speed detection unit detecting a driving speed of the vehicle, a weight sensor detecting a weight of the vehicle, a gradient sensor detecting inclination of road on which the vehicle is driving, a friction coefficient calculation unit calculating friction coefficient of road on which the vehicle is driving, and an information acquisition unit acquiring the weather information.

The information acquisition unit may include a weather information system mounted on the vehicle and receiving weather information of the current location of the vehicle from a remote weather server.

The information acquisition unit may include a rain water sensor mounted on a certain position of the autonomous driving vehicle to detect the amount of rain, a snow sensor mounted on a certain position of the autonomous driving vehicle to detect the amount of snow, and a fog detection sensor mounted on a certain of the autonomous driving vehicle to detect a forward view state of the vehicle.

### ADVANTAGEOUS EFFECTS

According to embodiments of the present invention, a method and an apparatus for controlling autonomous driving of a vehicle of the present invention can effectively prevent vehicle accidents in which the following vehicle collides with the preceding vehicle due to changes of stopping distance based on stopping variables, by calculating the stopping distance based on the stopping variables of the vehicle during autonomous driving and adaptively controlling a driving speed of the autonomous driving vehicle based on the calculated stopping distance.

### BRIEF DESCRIPTION OF THE DRAWINGS

FIG. 1 is a block diagram illustrating an apparatus for controlling autonomous driving of a vehicle according to an embodiment of the present invention.

FIG. 2 is a flow chart illustrating a main process controlling driving speed of autonomous driving vehicle based on stopping distance which vary depending on changes of stopping variables according to an embodiment of the present invention.

### DETAILED DESCRIPTION EMBODIMENTS OF THE INVENTIONS

Advantages and features of the present invention and methods of achieving them will become apparent with reference to the embodiments described below in detail in conjunction with the accompanying drawings. The present invention is not limited to the embodiments disclosed below, but may be embodied in various modifications and equivalent arrangements. The embodiments are provided to allow the disclosure of the present invention to be complete so that those of ordinary skill in the art of the present invention clearly understand the spirit and scope of the invention. The scope of the present invention should be defined by the appended claims.

In addition, detailed descriptions of well-known functions and configurations that may blur the gist of the present invention will be omitted. The terminology described below are defined in consideration of functions in the present invention, which may vary according to intention or common practice of users, operators, and so on. Accordingly, the terms used herein should be defined based on the technical idea described throughout the description of the present invention.

Hereafter, preferred embodiments of the present invention will be described in detail in conjunction with the accompanying drawings.

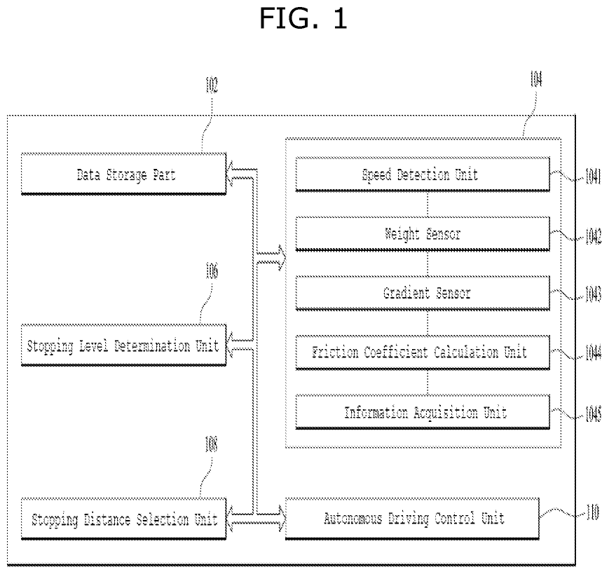

FIG. 1 is a block diagram illustrating an apparatus for controlling autonomous driving of a vehicle according to an embodiment of the present invention. The apparatus for controlling autonomous driving of a vehicle may comprise a data storage part 102, a stopping variable collection unit 104, a stopping level determination unit 106, a stopping distance selection unit 108, and an autonomous driving control unit 110.

The data storage part 102 may store a safe stopping distance table including a plurality of preset stopping levels respectively corresponding to a plurality of stopping distances determined based on a plurality of stopping variables required for calculating a safe stopping distance of the autonomous driving vehicle.

In this instance, the safe stopping distance table may be constructed through learning using an artificial intelligence (AI) algorithm. The stopping variables required for calculating the safe stopping distance of the autonomous driving vehicle may include a driving speed of the autonomous driving vehicle following the preceding vehicle, a weight of the autonomous driving vehicle, road inclination, road friction coefficient, weather information, and so on.

For example, the safety stopping distance table may include a total of 10 stopping levels, and each stopping level may be set as the below.

1) 10th stopping level: safe stopping distance 80 m-90 m

2) 9th stopping level: safe stopping distance 91 m-100 m

3) 8th stopping level: safe stopping distance 101 m-110 m

4) 7th stopping level: safe stopping distance 111 m-120 m

5) 6th stopping level: safe stopping distance 121 m-130 m

6) 5th stopping level: safe stopping distance 131 m-140 m

7) 4th stopping level: safe stopping distance 141 m-150 m

8) 3rd stopping level: safe stopping distance 151 m-160 m

9) 2nd stopping level: safe stopping distance 161 m-170 m

10) 1st stopping level: safe stopping distance 171 m or more

The stopping variable collection unit 104 may acquire current stopping variables required for calculating the safe stopping distance during autonomous driving of the vehicle, and transmit the acquired current stopping variables to the stopping level determination unit 106. For this purpose, the stopping variable collection unit 104 may include a speed sensing unit 1041, a weight sensor 1042, an inclination sensor 1043, a friction coefficient calculation unit 1044, and information acquisition part 1045. The current stopping variables may mean variables that is currently changeable.

The speed sensor 1041 may perform a function of detecting or collecting the driving speed of the autonomous driving vehicle during autonomous driving. The weight sensor 1042 may perform a function of detecting the weight of the autonomous driving vehicle. The inclination sensor 1043 may perform a function of detecting inclination of the road on which the autonomous driving vehicle is driving. The friction coefficient calculation unit 1044 may perform a function of calculating the friction coefficient of the road on which the autonomous driving vehicle is driving.

The information acquisition unit 1045 may provide a function of acquiring weather information of current location where the vehicle is autonomous-driving. In this instance, the weather information of the current location may include heavy rain, heavy snow, fog, and so on.

For acquiring the weather information, the information acquisition unit 1045 may include a weather information system that is mounted on the vehicle, and receives or collects the weather information of the current location of the autonomous driving vehicle from a remote weather server in real time at a preset time interval.

Unlike the mentioned above, the information acquisition unit 1045 may include a rain water sensor mounted on a certain position of the autonomous driving vehicle to detect the amount of rain, a snow sensor mounted on a certain position of the autonomous driving vehicle to detect the amount of snow, and a fog detection sensor mounted on a certain of the autonomous driving vehicle to detect a forward view state of the vehicle.

The stopping level determination unit 106 may provide a function of determining any one of the preset stopping levels as a current stopping level based on the current stopping variables of the vehicle, and transmitting the determined current stopping level to the stopping variable collection unit 104.

The stopping distance selection unit 108 may provide a function of selecting a certain stopping distance corresponding to the current stopping level determined by the stopping level determination part 106, as a current stopping distance, by searching the safe stopping distance table stored in the data storage part 102. Then, the stopping distance selection unit 108 may provide a function of transmitting the selected current stopping distance to the autonomous driving control part 110. In this instance, the current stopping level may be any one of the 10th stopping level to the 1st stopping level.

The autonomous driving control unit 110 may provide a function of controlling the driving speed of the vehicle so that the distance between the vehicle following a preceding vehicle and the preceding vehicle is maintained as the current stopping distance selected by the stopping distance selection unit 108.

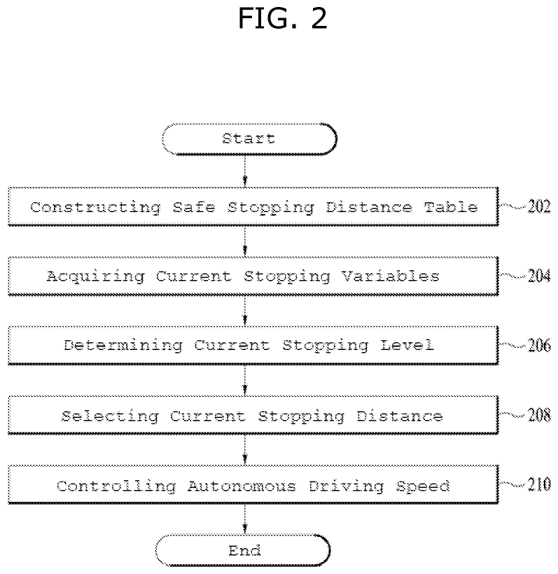

FIG. 2 is a flow chart illustrating a main process controlling driving speed of autonomous driving vehicle based on stopping distance which vary depending on changes of stopping variables according to an embodiment of the present invention.

Referring to FIG. 2, in a step 202, a safe stopping distance table including a plurality of preset stopping levels corresponding to a plurality of stopping distances determined based on a plurality of stopping variables required for calculating a safe stopping distance of the autonomous driving vehicle, is constructed, and stored in the data storage unit 102.

In this instance, the safe stopping distance table may be constructed through learning using an artificial intelligence (AI) algorithm. The stopping variables may include driving speed of the vehicle following the preceding vehicle, weight of the vehicle, road slope, road friction coefficient, weather information, and so on.

In a step 204, the stopping variable collection unit 104 acquires current stopping variables required for calculating a safe stopping distance during autonomous driving of the vehicle. The current stopping variables may mean variables which are currently changeable. The stopping variable collection unit 104 may include a speed detection unit 1041, a weight sensor 1042, a gradient sensor 1043, a friction coefficient calculation unit 1044, and an information acquisition unit 1045, and so on.

Accordingly, the speed sensor 1041 detects the driving speed of the vehicle during autonomous driving, the weight sensor 1042 detects the weight of the autonomous driving vehicle, and the inclination sensor 1043 detects the inclination of the road on which the autonomous driving vehicle is driving. The friction coefficient calculation unit 1044 calculates the road friction coefficient of the road on which the autonomous driving vehicle is driving, and the information obtaining unit 1045 acquires the weather information, such as rain, heavy rain, snow, heavy snow, fog, and fog formed in a forward view of the vehicle, of the current location where the autonomous driving vehicle is driving.

In a step 206, the stopping level determination unit 106 determines any one of preset stopping levels as a current stopping level based on the current stopping variables obtained by the stopping variable collection unit 104. The current stopping variables may mean stopping variables which are currently changeable.

In a step 208, the stopping distance selection unit 108 selects a certain stopping distance corresponding to the current stopping level determined by the stopping level determination part 106, as a current stopping distance, by searching the safe stopping distance table stored in the data storage part 102.

In a step 210, the autonomous driving control unit 110 controls the driving speed of the vehicle so that the distance between the vehicle following the preceding vehicle and the preceding vehicle is maintained as the current stopping distance selected by the stopping distance selection unit 108.

The description above is illustrative of the technical idea of the present invention, and those of ordinary skill in the art to which the present invention pertains may make various substitutions, modifications, and variations within the spirit and scope not departing from the essential features of the present invention. The embodiments disclosed in the present invention do not limit the technical idea of the present invention, but to explain. Accordingly, the sprit and scope of the present invention is not limited by these embodiments.

Therefore, the protection scope of the present invention should be interpreted by the appended claims, and all inventive concept within the spirit and scope equivalent thereto should be interpreted as being included in the scope of the present invention.

What is claimed is:

1. A method for controlling autonomous driving of a vehicle, the method comprising the steps of:
constructing a safe stopping distance table including a plurality of preset stopping levels corresponding to a plurality of stopping distances determined based on a plurality of stopping variables required for calculating a safe stopping distance of the vehicle;
acquiring current stopping variables required for calculating the safe stopping distance during autonomous driving of the vehicle;
determining any one of the preset stopping levels as a current stopping level based on the acquired current stopping variables;
selecting a certain stopping distance corresponding to the determined current stopping level as a current stopping distance, by searching the safe stopping distance table, and
controlling a driving speed of the vehicle so that a distance between the vehicle and a preceding vehicle is maintained as the selected current stopping distance.

2. The method of claim 1, wherein constructing the safe stopping distance table is performed through learning using an artificial intelligence (AI) algorithm.

3. The method of claim 1, wherein the stopping variables include at least two of driving speed of the vehicle, weight of the vehicle, road inclination, road friction coefficient, and weather information.

4. The method of claim 3, wherein the weather information is received from a remote weather server through a weather information system mounted on the vehicle.

5. The method of claim 3, wherein the weather information includes more than one of rain, heavy rain, snow, heavy snow, fog, fog formed in a forward view of the vehicle.
